(19) United States
(12) Patent Application Publication
(10) Pub. No.: US 2011/0189901 A1
(43) Pub. Date: Aug. 4, 2011

(54) WIRE CLAMP

(75) Inventors: Thierry LOPEZ, Voutezac (FR); Eric GERY, Conceze (FR)

(73) Assignee: MECATRACTION, Arnac Pompadour (FR)

(21) Appl. No.: 13/016,299

(22) Filed: Jan. 28, 2011

(30) Foreign Application Priority Data
Jan. 29, 2010 (FR) 1050624

(51) Int. Cl. H01R 4/36; H01R 43/00

(52) U.S. Cl. 439/814; 29/825

(57) ABSTRACT

A wire clamp for earthing a metal structure includes a body (10) having a tapped cylindrical cavity opening at a first end of the body, the other end being closed by a bottom (12) pierced with a hole (13) for the passage of a screw (20) for fastening the body onto metal structure, the body having over at least a part of the tapped cavity two through-slots facing each other that are formed along two generatrices of the cylindrical cavity and opening at the first end and a threaded plug (30) having a formation for rotational driving and adapted to helicoidally engage in the tapping of the cylindrical cavity to clamp a core of an electrical wire against the bottom of the slots, the plug having a central through-hole (32) adapted to allow passage of a tool for rotationally driving the screw for fastening the body onto the metal structure.

The present invention generally relates to wire clamps.

More particularly, the present invention concerns wire clamps adapted for the earthing of metal structures.

Wire clamps for earthing metal structures are adapted to be fastened to metal members of profiled section in a manner enabling conduction. They have clamping means for electrical connection to earthing wires. Such wire clamps are in particular used for earthing metal structures such as, for example, photovoltaic panel modules of aluminum as well as their support frames.

To that end, wire clamps are known for the earthing of a metal structure comprising a body having a tapped cylindrical cavity opening at a first end of the body, the other end being closed by a bottom pierced with a hole for the passage of a screw or a pin for fastening the body onto the metal structure.

On a part of the tapped cavity the body has two through-slots facing each other that are formed along two generatrices of the cylindrical cavity and opening at said first end. A threaded plug having a formation for rotational driving is helicoidally engaged in the tapping of the cylindrical cavity to clamp a core of an electrical wire against the bottom of the slots.

This structure makes it necessary to insert the screw or pin into the body of the wire clamp in a first phase then to insert the body of the screw in a hole of the metal structure then to tighten the screw against the metal structure, using, as appropriate, a nut and possibly a washer. In the case of metal structures that are covered, for example, with an anti-rust layer, it is necessary to provide a washer of serrated type enabling that layer to be passed through on tightening to provide good electric contact.

In a second phase, an electrical wire is inserted into the slots and the clamping plug is screwed on top.

Putting such a wire clamp in place requires the manipulation and assembly of numerous parts, which constitutes a loss of time for the installer, and increases the risk of losing components during the manipulation.

The present invention aims to mitigate these drawbacks. In general terms, the present invention aims to improve the known wire clamps and render them more reliable.

To that end the present invention provides a wire clamp for earthing a metal structure comprising a body having a tapped cylindrical cavity opening at a first end of the body, the other end being closed by a bottom pierced with a hole for the passage of a screw for fastening the body onto metal structure, the body having over at least a part of the tapped cavity two through-slots facing each other that are formed along two generatrices of the cylindrical cavity and opening at said first end and a threaded plug having a formation for rotational driving and adapted to helicoidally engage in the tapping of the cylindrical cavity to clamp a core of an electrical wire against the bottom of the slots, the plug having a central through-hole adapted to allow passage of a tool for rotationally driving the screw for fastening the body onto the metal structure.

Thus, advantageously, the wire clamp may be fastened onto the metal structure by tightening the fastening screw without having to demount the plug. There is thus no risk of losing the plug on installation of the cable clamp. Furthermore, the central hole facilitates the guiding of the tightening tool to a corresponding formation in the screw head.

Thus the screw cannot be lost when the plug is in place.

Advantageously, the screw being inserted beforehand in the corresponding hole and the plug screwed into the body, the latter can be fastened onto the metal structure without having to take out the plug, which contributes to the reliability of the assembly and facilitates putting in place. In practice, the risk of losing a component of the cable clamp according to the invention during its installation is nil, since the screw is captive of the body and of the plug.

According to an advantageous feature:
the hole at the bottom of the wire clamp body is of conical form widening towards the open end of the wire clamp body and the screw head is of complementary conical form.

Thus, advantageously the screw is centered and rotationally guided when tightened onto the metal structure to connect.

According to advantageous features, which may be combined:
said screw is a self-drilling screw or a self-tapping screw;
the plug has two diametrically opposite cut-outs forming formations for rotational driving for a flat-bladed screwdriver;
at least one of the following parts is formed from stainless steel: wire clamp body, plug, fastening screw;
the wire clamp body has an outer form adapted to cooperate with a tool for rotationally locking the body of the wire clamp;
said outer form is a hexagonal form over at least part of the height of the wire clamp body;

According to another aspect, the present invention concerns the implementation of a wire clamp comprising the steps of:
presenting the wire clamp to a metal structure to connect;
inserting into the central hole of the plug a rotational driving tool for the screw for fastening the body;
screwing the fastening screw into the metal structure in order to fasten the wire clamp to the metal structure to be connected;
inserting an earthing wire into the slots;
clamping the threaded plug against the wire using a tool for rotational driving adapted to engage with the threaded plug.

According to another aspect, the invention concerns a method of putting in place a wire clamp having the steps of:
presenting the wire clamp to a metal structure to connect;
placing a tool for rotational locking on the adapted outer form of the body of the wire clamp;
inserting into the central hole of the plug a rotational driving tool for the screw for fastening the body;
screwing the fastening screw into the metal structure in order to fasten the wire clamp to the metal structure to be connected;
inserting an earthing wire into the slots;
clamping the threaded plug against the wire using a tool for rotational driving adapted to engage with the threaded plug.

The disclosure of the invention will now be continued with the detailed description of an embodiment, given below by way of non-limiting example, with reference to the accompanying drawings. In the drawings:

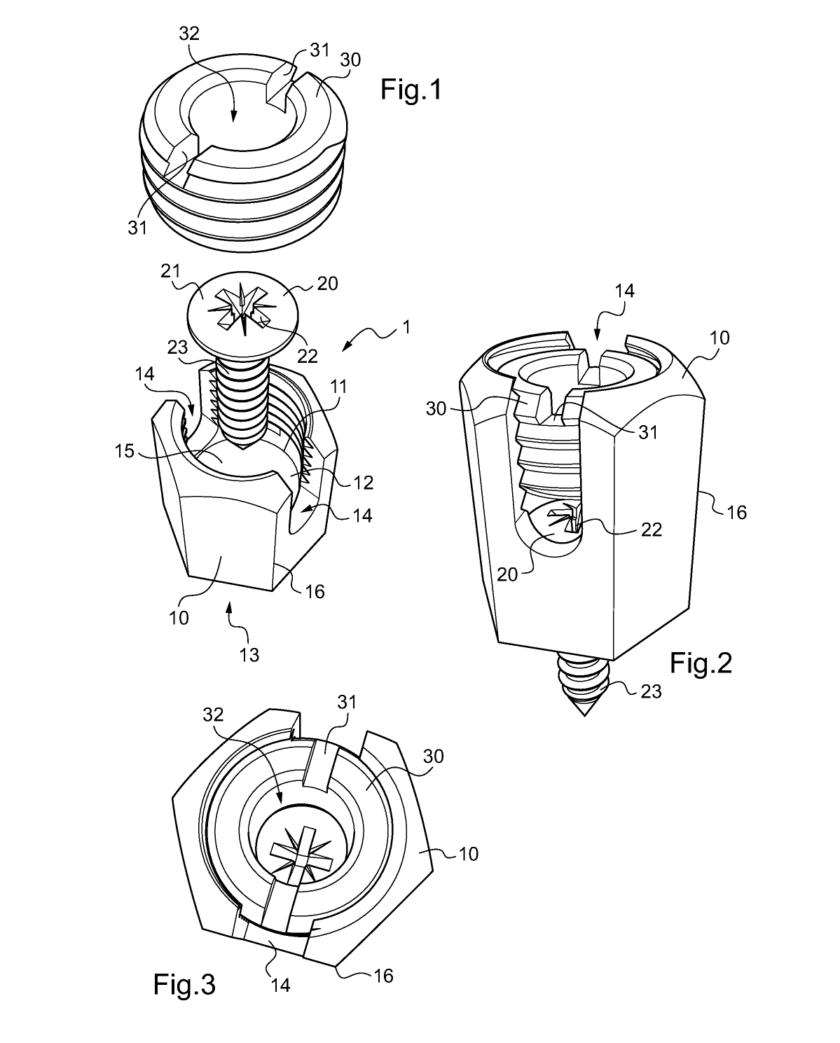

FIG. 1 is an exploded perspective view of a wire clamp according to the invention;

FIGS. 2 and 3 are two assembled perspective views of the same wire clamp;

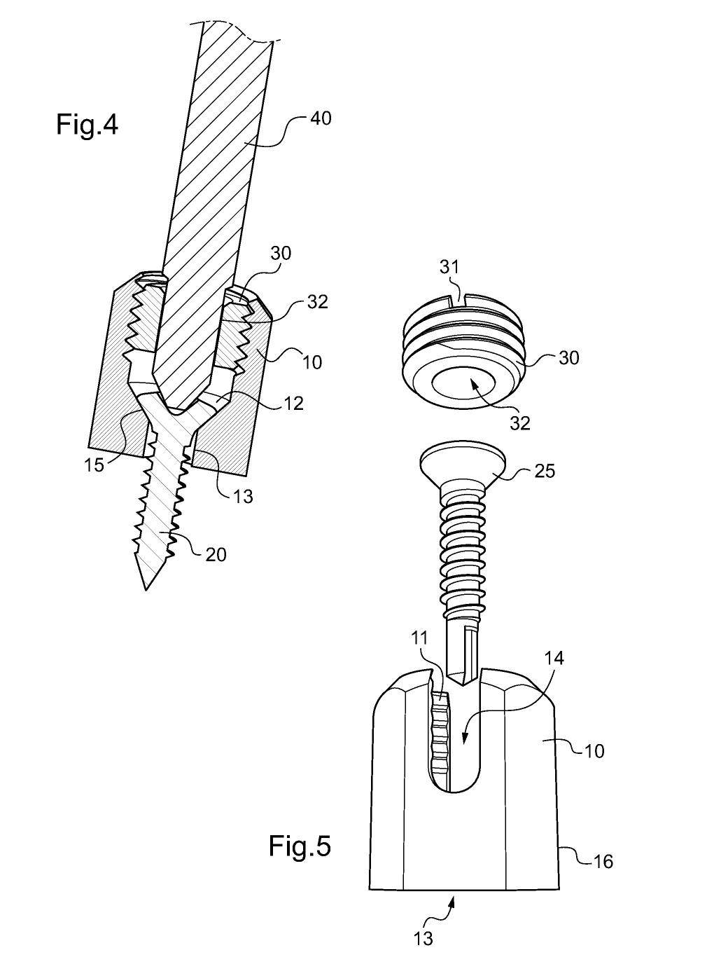

FIG. 4 is a cross-section view of the same wire clamp with a tightening tool inserted into the central hole of the plug;
FIG. 5 is an exploded perspective view of the same wire clamp using a different type of screw.

As can be seen in FIG. 1, a wire clamp 1 for earthing a metal structure (not shown) comprises a body 10 having a tapped cylindrical cavity 11 opening at the upper end of the body and closed by a bottom 12 pierced with a hole 13 for the passage of a screw 20 for fixing the body 10 onto the metal structure. Along two generatrices of the cylindrical cavity 11 the body 10 has two through-slots 14 facing each other and intended to receive an earthing wire (not shown).

A threaded plug 30 is adapted to helicoidally engage in the tapping of the cylindrical cavity 11. The plug has two diametrically opposite cut-outs 31 forming formations for rotational driving for a flat-bladed screwdriver in order to come to clamp the plug against the electrical wire placed against the bottom of the slots 14.

The screw 20 has a head 21 with a cross formation 22 for rotational driving and a threaded screw body 23.

The plug 30 furthermore has a central through-hole 32. As can be seen more particularly in FIGS. 2 and 3, the outer diameter of the screw head 21 is greater than the diameter of the central hole 32 of the plug 30. Thus, once the screw has been inserted into the hole 13 and the plug 30 has been screwed into the body 10, the screw 20 is captive of the wire clamp and cannot therefore be lost at the time of its installation.

As can be seen more particularly in FIG. 4, the hole 32 is however sufficient to allow a rotational driving tool 40 to pass to come to screw the fastening screw of the body 10 onto the metal structure (not shown) through the plug. In the example illustrated here, this is a screwdriver 40 for cross-head screws the end of which corresponds to the formation 22 of the screw.

In the example illustrated in FIGS. 1 to 4, it is a self-tapping screw. Thus, advantageously, it suffices to present the assembled wire clamp as seen in

FIGS. 2 to 4 in front of a hole pre-bored for that purpose on a metal structure to be earthed, then to screw the self-tapping screw into the material of the metal structure by passing the screwing tool into the hole 32 of the plug 30. It is then a matter of inserting an earthing wire laterally and radially into the slots 14 then of tightening the plug by rotationally driving it using a flat-bladed screwdriver via the cut-outs 31 provided for that purpose in the plug 30. Thus, the core of the electrical wire becomes clamped against the bottom of the slots 14 thereby establishing an electrical contact between the body of the wire clamp 10 and the core of the wire.

As can be seen more particularly in FIG. 4, in the example illustrated, the bottom 12 of the body of the wire clamp has a conical surface 15 making contact with the lower surface of the head 21 of the screw which surface is itself conical. This structure contributes to making good electrical contact between the screw 20 and the body of the wire clamp 10, and contributes to centering and guiding the screw in rotation when it is tightened.

As the screw is self-tapping, the electrical contact is established between the screw thread thereof and the tapping which it is caused to machine in the metal structure to be connected. Thus, in very simple manner, by performing two successive screwing operations without demounting parts, a metal structure is earthed particularly simply and effectively.

To avoid the body 10 of the wire clamp turning during tightening of the screw 20 or during tightening of the plug 30, or to orientate the two through-slots of the wire clamp in the desired direction, it has a hexagonal outer form 16 adapted to cooperate with a spanner enabling the operator to prevent the body 10 from rotating during the two successive screwing operations referred to above.

Other embodiments are within the capability of the person skilled in the art, such as two flats on respective opposite sides of the body to cooperate with a spanner or a radial through bore to cooperate with a rod for torsional immobilization.

In an embodiment not shown, the body 10 of the wire clamp has a hexagonal outer form from its base to a height substantially corresponding to the height of a spanner, then has an outer cylindrical form.

In the illustrated embodiment, the body of the wire clamp, the plug and the fastening screw 20 are formed from a material that is both conducting and corrosion-resistant such as a stainless steel.

FIG. 5 represents an exploded perspective view of the same wire clamp composed of a body 10 and a plug 30 in which a self-tapping screw 25 has been inserted.

The use of such a screw enables the wire clamp to be fastened to a metal structure which does not have any hole prior to that fastening. To that end, use is preferably made of a portable screwdriver with a bit adapted to pass through the hole 32 of the plug 30 in order to rotationally drive the screw 25 in similar manner to that represented in FIGS. 1 to 4. The electrical contact between the screw 25 and the metal structure is made in identical manner to that for the screw 20, i.e. via the screw thread of the screw 25 and the tapping of the metal structure resulting therefrom.

It should be noted that the cruciform formation 22 represented in the example described above may be replaced by any other formation within the capability of the person skilled in the art without departing from the scope of the invention. It may for example be a hexagonal socket formation or a formation for a flat-bladed screwdriver.

Numerous other variants are possible according to circumstances, and in this connection it is to be noted that the invention is not limited to the examples described and shown.

1. A wire clamp (1) for earthing a metal structure comprising a body (10) having a tapped cylindrical cavity (11) opening at a first end of the body, the other end being closed by a bottom (12) pierced with a hole (13) for the passage of a screw (20, 25) for fastening the body onto metal structure, the body having over at least a part of the tapped cavity two through-slots (14) facing each other that are formed along two generatrices of the cylindrical cavity and opening at said first end and
a threaded plug (30) having a formation (31) for rotational driving and adapted to helicoidally engage in the tapping of the cylindrical cavity to clamp a core of an electrical wire against the bottom of the slots (14), characterized in that the plug has a central through-hole (32) adapted to allow passage of a tool for rotationally driving the screw for fastening the body onto the metal structure.

2. A wire clamp according to claim 1, characterized in that it further comprises a fastening screw (20, 25) having a screw body (23) inserted into the hole (13) at the bottom of the body of the wire clamp and a screw head (21) having a rotational driving formation (22) accessible via the central hole (32) of the plug for a corresponding rotational driving tool, and in which the greatest width of the central hole is less than the smallest outer width of the fastening screw head (21).

3. A wire clamp according to 2, characterized in that the hole (12) at the bottom of the wire clamp body is of conical form (15) widening towards the open end of the wire clamp body and the screw head (21) is of complementary conical form.

4. A wire clamp according to claim 3, characterized in that said screw (20) is a self-drilling screw (25) or a self-tapping screw (20).

5. A wire clamp according to claim 2, characterized in that the plug (30) has two diametrically opposite cut-outs (31) forming formations for rotational driving for a flat-bladed screwdriver.

6. A wire clamp according to claim 2, characterized in that at least one of the following parts is formed from stainless steel: wire clamp body (10), plug (30), fastening screw (20,25).

7. A wire clamp according to claim 6, characterized in that the wire clamp body (10) has an outer form adapted to cooperate with a tool for rotationally locking the body of the wire clamp.

8. A wire clamp according to claim 7, characterized in that said outer form is a hexagonal form (16) over at least part of the height of the wire clamp body.

9. A method of putting in place a wire clamp according to claim 2, characterized in that it comprises the steps of:
presenting the wire clamp (10) to a metal structure to connect;
inserting into the central hole (32) of the plug (30) a rotational driving tool for the screw for fastening the body;
screwing the fastening screw (20, 25) into the metal structure in order to fasten the wire clamp to the metal structure to be connected;
inserting an earthing wire into the slots (14);
clamping the threaded plug (30) against the wire using a tool for rotational driving adapted to engage with the threaded plug.

10. A method of putting in place a wire clamp according to claim 7, characterized in that it has the steps of:
presenting the wire clamp (10) to a metal structure to connect;
placing a tool for rotational locking on the adapted outer form (16) of the body (10) of the wire clamp;
inserting into the central hole (32) of the plug (30) a rotational driving tool onto the screw for fastening the body;
screwing the fastening screw (20, 25) into the metal structure in order to fasten the wire clamp to the metal structure to be connected;
inserting an earthing wire into the slots (14);
clamping the threaded plug (30) against the wire using a tool for rotational driving adapted to engage with the threaded plug.

11. A wire clamp according to claim 3, characterized in that the plug (30) has two diametrically opposite cut-outs (31) forming formations for rotational driving for a flat-bladed screwdriver.

12. A wire clamp according to claim 3, characterized in that at least one of the following parts is formed from stainless steel: wire clamp body (10), plug (30), fastening screw (20,25).

13. A method of putting in place a wire clamp according to claim 3, characterized in that it comprises the steps of:
presenting the wire clamp (10) to a metal structure to connect;
inserting into the central hole (32) of the plug (30) a rotational driving tool for the screw for fastening the body;
screwing the fastening screw (20, 25) into the metal structure in order to fasten the wire clamp to the metal structure to be connected;
inserting an earthing wire into the slots (14);
clamping the threaded plug (30) against the wire using a tool for rotational driving adapted to engage with the threaded plug.

14. A method of putting in place a wire clamp according to claim 8, characterized in that it has the steps of:
presenting the wire clamp (10) to a metal structure to connect;
placing a tool for rotational locking on the adapted outer form (16) of the body (10) of the wire clamp;
inserting into the central hole (32) of the plug (30) a rotational driving tool onto the screw for fastening the body;
screwing the fastening screw (20, 25) into the metal structure in order to fasten the wire clamp to the metal structure to be connected;
inserting an earthing wire into the slots (14);
clamping the threaded plug (30) against the wire using a tool for rotational driving adapted to engage with the threaded plug.
